(19) United States
(12) Patent Application Publication
(10) Pub. No.: US 2016/0102112 A1
(43) Pub. Date: Apr. 14, 2016

(54) DINITROSYL IRON COMPLEXES, USES THEREOF, AND WATER SPLITTING DEVICE USING THE SAME

(71) Applicant: National Tsing Hua University, Hsinchu City (TW)

(72) Inventors: Wen-Feng LIAW, Hsinchu City (TW); Tzung-Wen CHIOU, Hsinchu City (TW); Ying-Hao WU, Hsinchu City (TW)

(21) Appl. No.: 14/820,338

(22) Filed: Aug. 6, 2015

(30) Foreign Application Priority Data
Oct. 9, 2014 (TW) 103135209

(51) Int. Cl. C07F 15/02; C25B 1/04; C25B 9/00; C01B 3/04

(52) U.S. Cl. CPC C07F 15/025; C01B 3/042; C25B 1/04; C25B 9/00

(57) ABSTRACT

Dinitrosyl iron complexes are disclosed, which are represented by the following formula (I):

[(R₁R₂N(CH₂)ₙNR₃(CH₂)ₘNR₄R₅)Fe(NO)₂]^{z} (I)

wherein the definitions of R₁, R₂, R₃, R₄, R₅, n, m and z are the same as those defined in the specification. In addition, the present invention further provides a use of the aforementioned dinitrosyl iron complexes, and a water splitting device using the same.

### CROSS REFERENCE TO RELATED APPLICATION

This application claims the benefits of the Taiwan Patent Application Serial Number 103135209, filed on Oct. 9, 2014, the subject matter of which is incorporated herein by reference.

### BACKGROUND OF THE INVENTION

1. Field of the Invention

The present invention relates to dinitrosyl iron complexes, a use thereof and a water splitting device using the same and, more particularly dinitrosyl iron complexes for effectively splitting water to generate hydrogen gas, a use thereof and a water splitting device using the same.

2. Description of Related Art

A growing awareness of issues to air pollution and climate change has made the search for clean and sustainable energy. Herein, fuel cells using hydrogen gas is one of the alternative energy without using carbon source. One of the current methods for generating hydrogen gas is water splitting.

To effectively split water to generate hydrogen gas at room temperature, a Pt electrode is usually used as a working electrode. Although Pt electrode has high catalytic activity for water splitting, its high cost prohibits its widespread application. Hence, heavy research is made to synthesize earth-abundant element-containing molecular catalysts for hydrogen generation from water.

The known catalysts for hydrogen generation include complexes containing Co, Ni or Mo, winch can improve the water splitting rate through electrocatalytic or photocatalytic reaction. However, these complexes have poor alkali resistance, so buffer solution has to be added into the water to adjust the pH value. Meanwhile, these molecular catalysts can not serve as the efficient catalysts for long-term generation of H₂.

Therefore, it is desirable to provide a novel catalyst, which can be applied on the water splitting to effectively generate hydrogen gas.

### SUMMARY OF THE INVENTION

An object of the present invention is to provide a dinitrosyl iron complex and a use thereof, wherein the dinitrosyl iron complex can efficiently catalyze water splitting to generate hydrogen.

Another object of the present invention is to provide a water splitting device, wherein the dinitrosyl iron complex of the present invention is added into the water, so that the water splitting device can efficiently split the water to generate hydrogen.

To achieve the object, the dinitrosyl iron complex of the present invention is represented by the following formula (I):

[(R₁R₂N(CH₂)ₙNR₃(CH₂)ₘNR₄R₅)Fe(NO)₂]^{z} (I)

wherein, each R₁, R₂, R₃, R₄ and R₅ is independently selected from the group consisting of H, halogen, alkyl, alkoxy, aryl, and heteroaryl; n is 2, 3 or 4; m is 2, 3, or 4; and z is −2, −1, 0, +1 or +2.

In the present invention, alkyl, alkoxy, aryl, and heteroaryl mentioned herein include both substituted and unsubstituted moieties, unless specified otherwise. Possible substituents on alkyl, alkoxy, aryl, and heteroaryl include, but are not limited to, alkyl, halogen, alkoxy, heterocyclic group or aryl.

In the present invention, “halogen” includes F, Cl, Br and I; preferably is F, Cl or Br; and more preferably is Cl or Br. The term “alkyl” refers to linear and branched alkyl; preferably, includes linear or branched. C₁₋₂₀ alkyl; more preferably, includes linear or branched C₁₋₁₂ alkyl; and most preferably, includes linear or branched C₁₋₆ alkyl. Specific examples of alkyl include, but are not limited to methyl, ethyl, n-propyl, iso-propyl n-butyl, sec-butyl, iso-butyl, tert-butyl, pentyl, neo-pentyl or hexyl. The term “alkoxy” refers to a moiety that the alkyl defined in the present invention coupled with an oxygen atom; preferably includes linear or branched C₁₋₂₀ alkoxy; more preferably, includes linear or branched C₁₋₁₂ alkoxy; and most preferably, includes linear or branched C₁₋₆ alkoxy. Specific examples of alkoxy include, but are not limited to, methoxy, ethoxy, n-propoxy, iso-propoxy, n-butoxy, iso-butoxy, sec-butoxy tert-butoxy pentyloxy neo-pentyloxy or hexyloxy. The term “alkenyl” refers to a linear or branched hydrocarbon moiety that contains at least one double bond; preferably, includes a linear or branched hydrocarbon moiety containing at least one double bond; more preferably, includes a linear or branched hydrocarbon C₂₋₁₂ moiety containing at least one double bond; and most preferably, includes a linear or branched hydrocarbon C₂₋₆ moiety containing at least one double bond. Specific examples of alkenyl include, but are not limited to, ethenyl, propenyl, allyl, or 1,4-butadienyl. The term “aryl” refers to a monovalent 6-carbon monocyclic, 10-carbon bicyclic, or 14-carbon tricyclic aromatic ring system. Specific examples of aryl include, but are not limited to, phenyl, naphthyl, pyrenyl, anthracenyl or phenanthryl; and preferably, the aryl is phenyl. The term “heterocyclic group” refers to a 5-8 membered monocyclic, 8-12 membered bicyclic or 11-14 membered tricyclic heteroaryl or heterocycloalkyl having at least one heteroatom which is selected from the group consisting of O, S and N. Specific examples of heterocyclic group include, but are not limited to, pyridyl, furyl, thiazolyl, imidazolyl or thienyl.

In the dinitrosyl iron complex of the present invention, each R₁, R₂, R₃, R₄ and R₅ can be independently selected from the group consisting of H, halogen, alkyl, alkoxy, aryl, and heteroaryl; preferably, each R₁, R₂, R₃, R₄ and R₅ is independently selected from the group consisting of H, alkyl, aryl, and pyridine; more preferably, each R₁, R₂, R₃, R₄ and R₅ is independently H or alkyl; further more preferably, each R₁, R₂, R₃, R₄ and R₅ is independently selected from the group consisting of H, methyl, ethyl, n-propyl, iso-propyl, n-butyl, sec-butyl, iso-butyl and tert-butyl; and most preferably, each R₁, R₂, R₃, R₄ and R₅ is independently selected from the group consisting of H, methyl and ethyl.

In addition, in the dinitrosyl iron complex of the present invention, R₁, R₂, R₃, R₄ and R₅ can be identical to or different from each other. Preferably, R₁ and R₂ are identical, and R₄ and R₅ are identical. More preferably, all R₁, R₂, R₃, R₄ and R₅ are identical substituents. Further more preferably, all R₁, R₂, R₃, R₄ and R₅ are identical substituents, and are H, methyl, ethyl, n-propyl, iso-propyl, n-butyl, sec-butyl, iso-butyl or tert-butyl. Most preferably, all R₁, R₂, R₃, R₄ and R₅ are identical substituents, and are H, methyl or ethyl.

Furthermore, in the dinitrosyl iron complex of the present invention, n and m can be identical to or different from each other, and are integers between 2 and 4. Preferably, n and m are the same integers between 2 and 4. More preferably, both n and m are 2.

In addition, in the dinitrosyl iron complex of the present invention, z can be −2, −1, 0, +1 or +2. Preferably, z is −1, 0 or +1. More preferably, z is 0 or +1.

In the dinitrosyl iron complex of the present invention, the dinitrosyl iron complex represented by the formula (I) can be the dinitrosyl iron complex represented by the following formula (II) or (III), and preferably the dinitrosyl iron complex represented by the following formula (III):

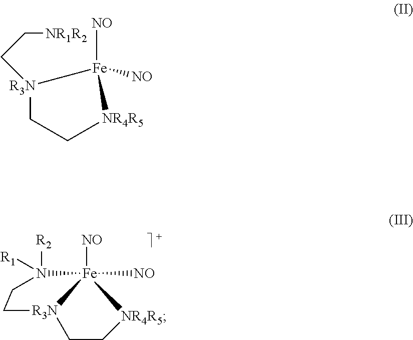

wherein the definitions of R₁, R₂, R₃, R₄ and R₅ are the same as those illustrated above.

In addition, the present invention further provides a use of the aforementioned dinitrosyl iron complex for splitting water to generate hydrogen.

Furthermore, the present invention further provides a water splitting device using the aforementioned dinitrosyl iron complex, which comprises: a container; water disposed in the container, wherein the aforementioned dinitrosyl iron complex is added into the water; a first electrode, disposed in the container and immersed in the water; and a second electrode, disposed in the container, immersed in the water and opposite to the first electrode.

In the present invention, the term “water” refers to pure water or any other aqueous solution. Specific examples thereof include, but are not limited to pure water or sea water. Especially when the water is sea water, splitting the sea water can generate not only hydrogen but also chlorine due to the sea water containing chloride ions.

Co, Ni and Mo complexes are usually used to catalyze water splitting to generate hydrogen for those devices using hydrogen such as fuel cells. However, the alkali resistances of the Co, Ni and Mo complexes are not good enough. In addition, the water splitting has to be performed in the presence of organic solvents when using the Co, Ni and Mo complexes as catalysts. In order to improve the limitations of the water splitting using the Co, Ni and Mo complexes as the catalyst, the present invention provides a novel dinitrosyl iron complex having high alkali resistance to replace the conventional Co, Ni and Mo complexes. When the dinitrosyl iron complex of the present invention is applied to the water splitting process and device, it can efficiently catalyze the water splitting, and no acids and organic solvents have to be added. In addition, the dinitrosyl iron complex of the present invention has high alkali resistance, and thus the expensive Pt electrode can be replaced with the cheap glass-carbon electrode as the working electrode. Meanwhile, if the dinitrosyl iron complex of the present invention is used to catalyze the sea water splitting, another benefit is that chlorine can also be simultaneously produced.

Other objects, advantages, and novel features of the invention will become more apparent from the following detailed description when taken in conjunction with the accompanying drawings.

### BRIEF DESCRIPTION OF THE DRAWINGS

FIG. 1 shows a single-crystal X-ray structure of a dinitrosyl iron complex represented by the formula (I-2) according, to one preferred embodiment of the present invention;

FIG. 2 shows a single-crystal X-ray structure of a dinitrosyl iron complex represented by the formula (I-4) according to one preferred embodiment of the present invention;

FIG. 3 shows an IR spectrum of a dinitrosyl iron complex represented by the formula (I-1) according to one preferred embodiment of the present invention;

FIG. 4 shows an IR spectrum of a dinitrosyl iron complex represented by the formula (I-2) according to one preferred embodiment of the present invention;

FIG. 5 shows an IR spectrum of a dinitrosyl iron complex represented by the formula (I-3) according to one preferred embodiment of the present invention;

FIG. 6 shows an Electron paramagnetic resonance (EPR) spectrum of a dinitrosyl iron complex represented by the formula (I-3) according to one preferred embodiment of the present invention;

FIG. 7 shows an IR spectrum of a dinitrosyl iron complex represented by the formula (I-4) according to one preferred embodiment of the present invention;

FIG. 8 shows an EPR spectrum of a dinitrosyl iron complex represented by the formula (I-4) according to one preferred embodiment of the present invention;

FIGS. 9A and 9B show results of a cyclic voltammetry according to one preferred embodiment of the present invention;

FIG. 10 shows a result of a cathodic scan according to one preferred embodiment of the present invention;

FIG. 11 shows a relation of charge build-up versus time at various potentials for a dinitrosyl iron complex represented by the formula (I-4) according to one preferred embodiment of the present invention;

FIG. 12 shows a relation of charge build-up versus time at a potential of −1.30 V for a dinitrosyl iron complex represented by the formula (I-4) according to one preferred embodiment of the present invention; and

FIG. 13 is a schematic view showing a water splitting device according to one preferred embodiment of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Preparation of Compounds (I-1)-(I-4)

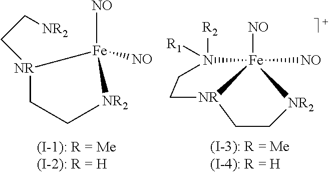

Compounds [Na][NO₂] (10.0 mmol, (1690 g) and 18-crown-6-ether (10.0 mmol, 2.643 g) were dissolved in THF in the 50 mL Schlenk flask, and the commercial [Fe(CO)₅] (10.0 mmol, 1.348 mL) was added into the THF mixture solution at 0° C. The resulting solution was stirred at ambient temperature overnight. The reaction was monitored with FTIR. IR spectrum (IR 1983 m, 1877 s (ν_{CO}), 1647 m (ν_{NO}) cm⁻¹ (THF)) was assigned to the formation of [Na-18-crown-6-ether][Fe(CO)₃(NO)]. Then, hexane was added to precipitate the yellow solid [Na-18-crown-6-ether][Fe(CO)₃(NO)] (3.885 g, 85%). Compounds [Na-18-crown-6-ether][Fe(CO)₃(NO)] (2.0 mmol, 0.914 g) and [NO][BF₄] (2.0 mmol, 0.234 were loaded into 25 mL Schlenk flask, and 20 mL of THF was added at 0° C. The resulting solution was stirred about 30 min at 0° C. and IR spectrum (IR 2088 s, 2037 s (ν_{CO}), 1808 s, 1760 s (ν_{NO}) cm⁻¹ (THF)) was assigned to the formation of [Fe(CO)₂(NO)₂].

THF solution (20 mL) of Fe(CO)₂(NO)₂ (˜1.0 mmol) and pentamethyldiethylenetriamine (PMDTA) (1.0 mmol, 0.11 mL) were reacted for 4 hr at ambient temperature, followed by adding hexane into the reaction solution to precipitate the brown solid [(CH₃)₂N(CH₂)₂NCH₃(CH₂)₂N(CH₃)₂)Fe(NO)₂]⁰ represented by the formula (I-1).

In addition, THF solution (20 mL) of Fe(CO)₂(NO)₂ (˜1.0 mmol) and diethylenetriamine (DTA) (1.0 mmol, 0.21 mL) were also reacted for 4 hr at ambient temperature, followed by adding hexane into the reaction solution to precipitate the brown solid [H₂N(CH₂)₂NH(CH₂)₂NH₂)Fe(NO)₂] represented by the formula (I-2).

Each crystal was mounted on a glass fiber and quickly coated with an epoxy resin. Unit-cell parameters were obtained by least-squares refinement. Herein, diffraction measurements for complexes (I-1) and (I-2) were carried out on a Bruker Kappa Apex DUO diffractometer with graphite-monochromated Mo Kα radiation (λ=0.7107 Å). Least-squares refinement of the positional and anisotropic thermal parameters of all non-H atoms and fixed H atoms was based on F². A SADABS absorption correction was made. The SHELXTL structural refinement program was employed. The single-crystal X-ray structure of the dinitrosyl iron complex (I-2) is shown in FIG. 1. As shown in FIG. 1, the geometry of Fe center of the dinitrosyl iron complex (I-2) is a distorted tetrahedral with N1-Fe1-N2 bond angle of 81.89(9)°. The detailed crystal data and structure refinement for the dinitrosyl iron complex (I-2) are shown in the following Table 1.

TABLE 1

| Empirical formula | C4 H13 Fe N5 O2 | |
|---|---|---|
| Formula weight | 219.04 | |
| Temperature | 100(2) K | |
| Wavelength | 0.71073 Å | |
| Crystal system | Monoclinic | |
| Space group | P 21/n | |
| | a = 7.8383(4) Å | α = 90° |
| | b = 8.3171(3) Å | β = 99.801(2)° |
| | c = 13.7034(7) Å | γ = 90° |

| | |
|---|---|
| Volume | 880.31(7) Å³ |
| Z | 4 |
| Density (calculated) | 1.653 Mg/m³ |
| Absorption coefficient | 1.684 mm⁻¹ |
| F(000) | 456 |
| Crystal size | 0.22 × 0.06 × 0.06 mm³ |
| θ range for data collection | 2.806° to 26.378° |
| Index range | −9 <= h <= 9, −10 <= k <= |
| | 10, −16 <= l <= 17 |
| Reflections collected | 7625 |
| Independent reflections | 1796 [R(int) = 0.0556] |
| Completeness to θ = 25.242° | 100.0% |
| Absorption collection | Semi-empirical from equivalents |
| Max. and min. transmission | 0.9485 and 0.7983 |
| Refinement method | Full-matrix least-squares on F² |
| Data/restraints/parameters | 1796/0/109 |
| Goodness-of-fit on F² | 1.261 |
| Final R indices [I > 2sigma(I)] | R1 = 0.0271, wR2 = 0.0728 |
| R indices (all data) | R1 = 0.0371, wR2 = 0.1179 |
| Extinction coefficient | n/a |
| Largest diff. peak and hole | 0.530 and −0.925 e.Å⁻³ |

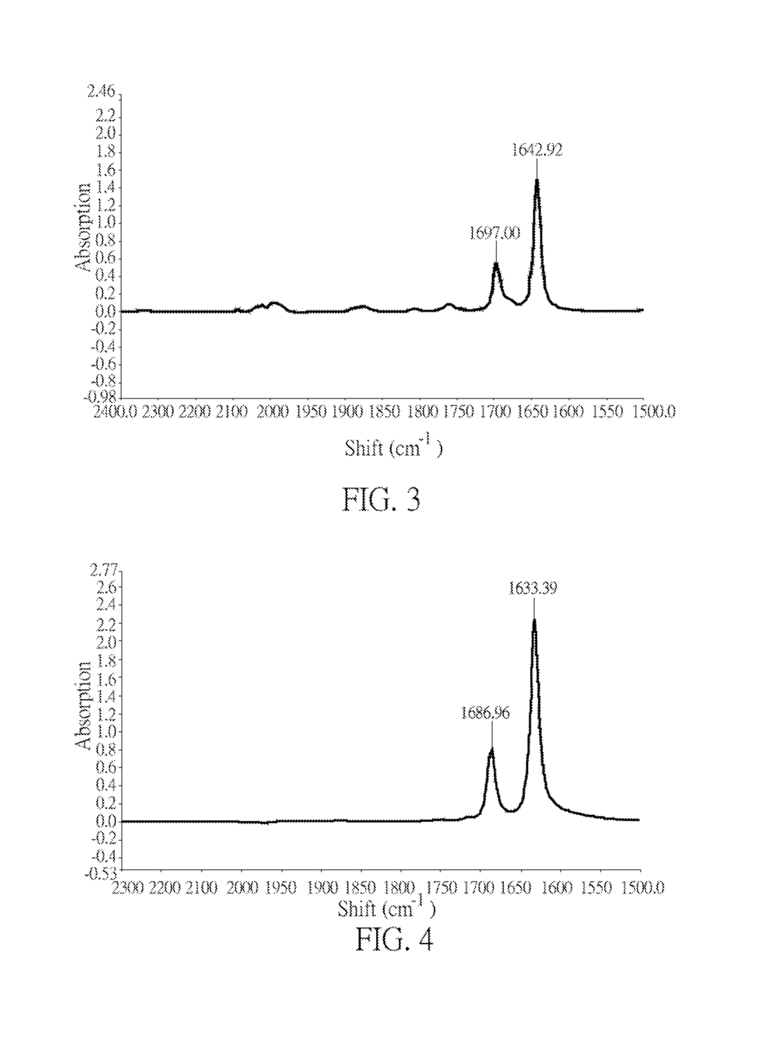

Herein, cyclic voltammetry was performed to obtain the reduction-oxidation reactivity of the complexes (I-1) and (I-2) toward water. Electrochemical measurements were performed with a CHI model 621b potentiostat (CH Instrument) instrumentation. Cyclic voltammograms were obtained from 2.0 mM analyte concentration in O₂-free MeCN using 0.1 M [n-Bu₄N][PF₆] as the supporting electrolyte. The potential was measured at 298 K vs a Ag/AgNO₃ reference electrode by using a glassy carbon working electrode (surface area=(0.0707 cm²) and a platinum wire auxiliary electrode at a scan rate of 0.05 V/s. The results indicate that, when 2 mM of the complexes (I-1) and (I-2) in MeCN reacted with 0.1 M [n-Bu₄N][PF₆], the reversible electrochemical interconversion occurs at E_{1/2}=−0.92 V and −0.81 V (versus Fc/Fc+) respectively. In addition, infrared spectroscopy was also performed on complexes of (I-1) and (I-2). Infrared spectra of the νNO stretching frequencies were recorded on a PerkinElmer model Spectrum One B spectrometer with sealed solution cells (0.1 mm, CaF₂ windows) or KBr. The results indicate that, in THF, IR ν_{NO} frequencies of 1697, 1643 cm⁻¹ are exhibited by the complex (I-1), compared to 1686, 1634 cm⁻¹ exhibited by the complex (I-2). The IR spectra of the complexes (I-1) and (I-2) are shown in FIGS. 3 and 4.

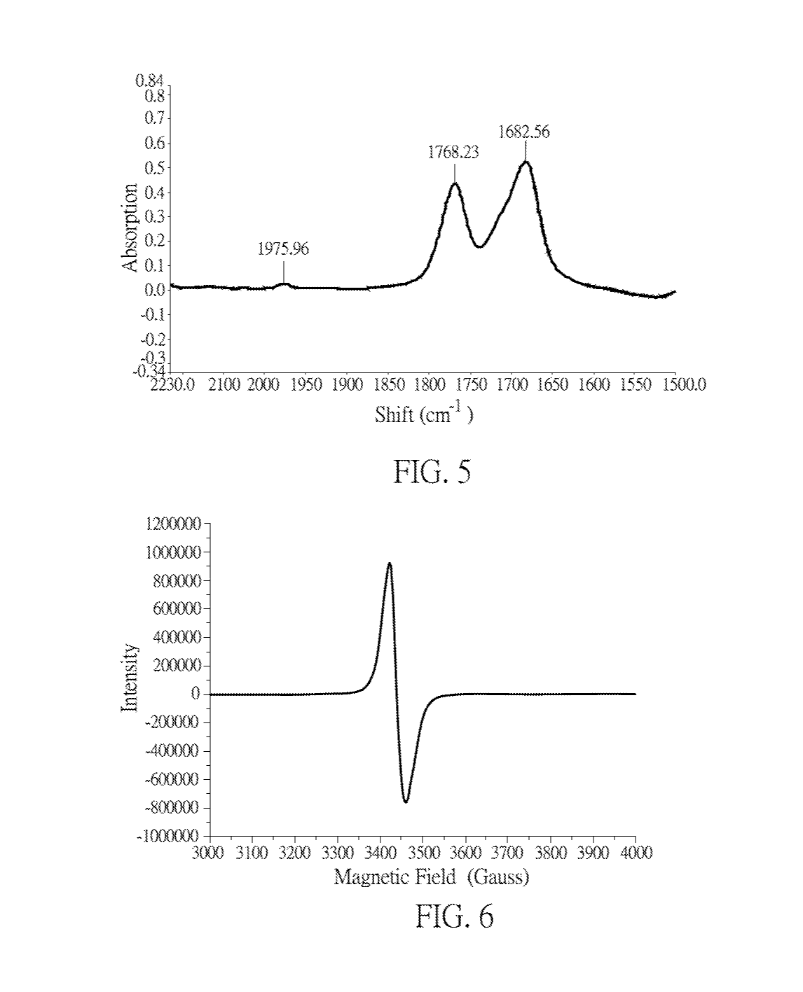

Upon addition of one equiv of [NO][BF₄] to the CH₃CN solution of the complex (I-1), IR ν_{NO} frequencies shifting from (1697, 1643 cm⁻¹) shown in FIG. 3 to (1768, 1683 cm⁻¹) shown in FIG. 5 indicate the formation of the complex (I-3). After the mixture solution of the complex (I-1) and [NO][BF₄] was stirred for 10 minutes at room temperature, the THF-ether was added to precipitate the brown solid, which is [(CH₃)₂N(CH₂)₂NCH₃(CH₂)₂N(CH₃)₂)Fe(NO)₂]⁺[BF₄]⁺ (I-3). The obtained complex (I-3) was dissolved in MeCN and Electron spin resonance (EPR) measurements were performed at the X band using a Bruker ELEXSYS E-580 spectrometer. X-band EPR spectrum of the complex (I-3) in MeCN were obtained with a microwave power of 15.0 mW, a frequency of 9.662 GHz, and a modulation amplitude of 1.6 G at 100 kHz. As shown in FIG. 6, EPR spectrum of the complex (I-3) displays an isotropic signal g value 2.007 at 77 K in MeCN.

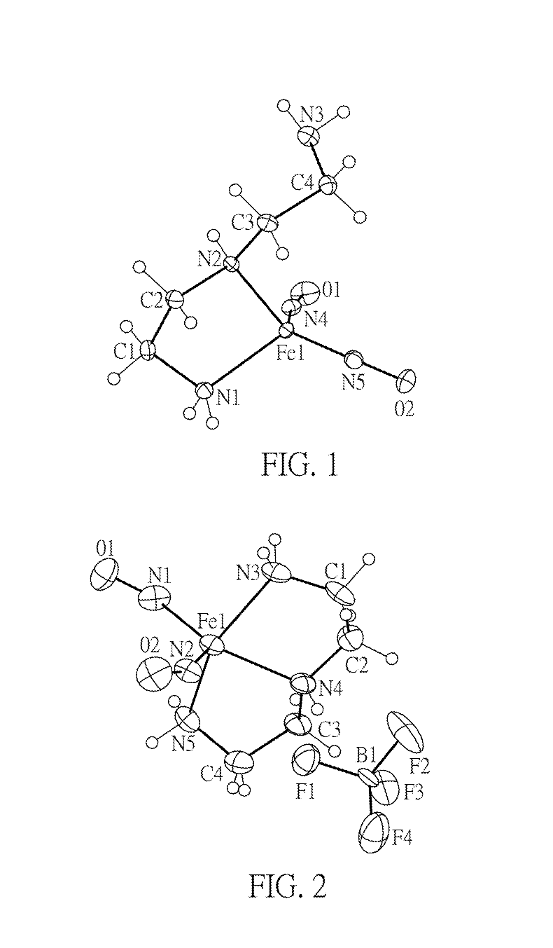

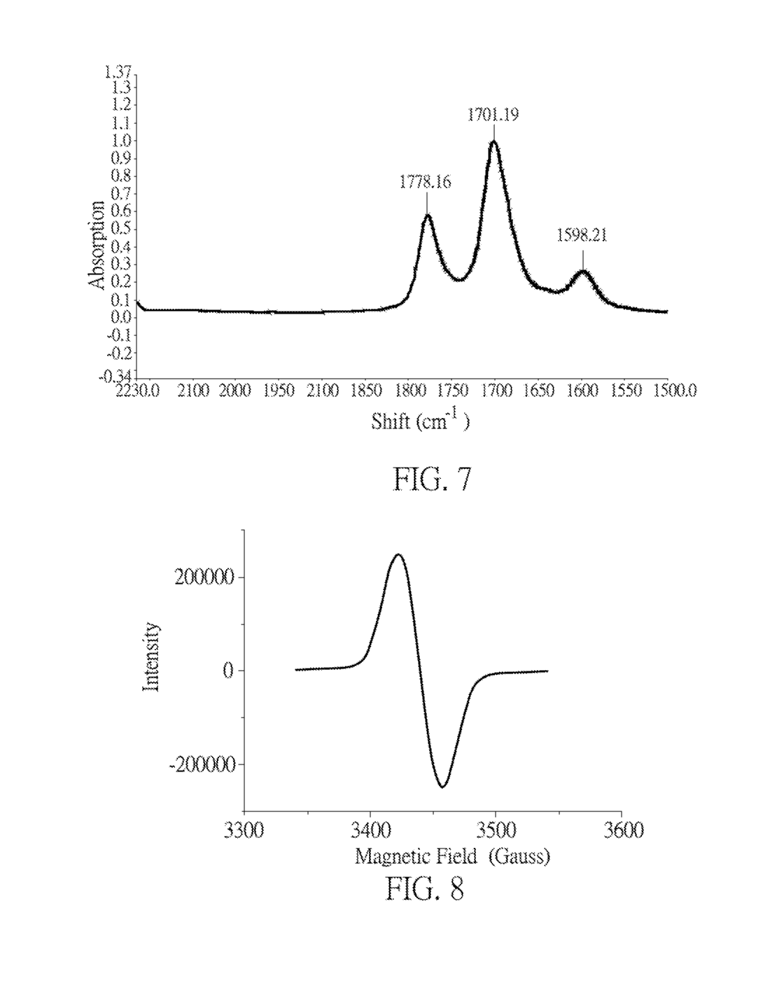

In addition, upon addition of one equiv of [NO][BF₄] to the CH₃CN solution of the complex (I-2), IR ν_{NO} frequencies shifting from (1686, 1634 cm⁻¹) shown in FIG. 4 to (1779, 1702 cm⁻¹) shown in FIG. 7 indicate the formation of the complex (I-4). After the mixture solution of the complex (I-2) and [NO][BF₄] was stirred for 10 minutes at room temperature, the THF-ether was added to precipitate the brown solid, which is [H₂N(CH₂)₂NH(CH₂)₂NH₂)Fe(NO)₂]⁺[BF₄]⁻ (I-4). The single-crystal X-ray structure of the dinitrosyl iron complex (I-4) is shown in FIG. 2; and the detailed crystal data and structure refinement for the dinitrosyl iron complex (I-4) are shown in the following Table 2. As shown in FIG. 2, the geometry around Fe center of the complex (I-4) is a distorted trigonal bipyramidal or square pyramidal. Examples of the counter ion include [BF₄]⁻. In addition, coordination of pendant amine group toward the [Fe(NO)₂] core in the complex (I-4) may stabilize the complex in a square pyramidal coordination environment with one of the NO ligand occupying the axial position. Furthermore, the obtained complex (I-4) was also dissolved in MeCN, and EPR measurements were performed at the X band using a Bruker ELEXSYS E-579 spectrometer. X-band EPR spectrum of the complex (I-4) in MeCN were obtained with a microwave power of 15.0 mW, a frequency of 9.660 GHz, and a modulation amplitude of 1.6 G at 100 kHz. As shown in FIG. 8, EPR spectrum of the complex (I-4) displays an isotropic signal g value 2.008 at 77 K in MeCN.

TABLE 2

| Empirical formula | C4 H13 B F4 Fe N5 O2 | |
|---|---|---|
| Formula weight | 305.85 | |
| Temperature | 100(2) K | |
| Wavelength | 0.71073 Å | |
| Crystal system | Monoclinic | |
| Space group | P21/n | |
| | a = 8.689(2) Å | α = 90° |
| | b = 11.594(3) Å | β = 90.193(5)° |
| | c = 11.912(3) Å | γ = 90° |

| | |
|---|---|
| Volume | 1200.0(6) Å³ |
| Z | 4 |
| Density (calculated) | 1.693 Mg/m³ |
| Absorption coefficient | 1.307 mm⁻¹ |
| F(000) | 620 |
| Crystal size | 0.20 × 0.20 × 0.12 mm³ |
| θ range for data collection | 1.709° to 26.480° |
| Index range | −10 <= h <= 10, −14 <= k <= |
| | 14, −13 <= l <= 14 |
| Reflections collected | 9209 |
| Independent reflections | 2374 [R(int) = 0.0257] |
| Completeness to θ = 25.242° | 99.3% |
| Absorption correction | Semi-empirical from equivalents |
| Max. and min. transmission | 0.9485 and 0.8250 |
| Refinement method | Full-matrix least-squares on F² |
| Data/restraints/parameters | 2374/0/155 |
| Goodness-of-fit on F² | 1.122 |
| Final R indices [I > 2sigma(I)] | R1 = 0.0656, wR2 = 0.1713 |
| R indices (all data) | R1 = 0.0682, wR2 = 0.1726 |
| Extinction coefficient | n/a |
| Largest diff peak and hole | 1.021 and −0.649 e.Å⁻³ |

### Preparation of Hydrogen (and Chlorine) Gas

Hereinafter, the obtained complexes (I-3) and (I-4) were used to perform water splitting reaction.

0.1 M KCl aqueous solution, 0.1 M Na₂SO₄ aqueous solution or sea water as a proton provider was respectively placed into containers. A glassy carbon electrode as a working electrode and a Pt electrode as an glassy auxiliary electrode were immersed into the container. In addition, the complexes (I-3) and (I-4) were also added into the KCl aqueous solution, Na₂SO₄ aqueous solution or the sea water for water splitting. Then, voltage was provided onto the working electrode and the auxiliary electrode to perform the water splitting reaction.

Compared to the high potential of −1.04 V for direct reduction of water using glassy carbon as working electrode, aerobic aqueous solution of 1 mM of the complex (I-3) with 0.1 M KCl electrolyte exhibits a reduction response as a tail rising up from −0.63 V (versus standard hydrogen electrode (SHE) as a reference electrode) in addition to the reversible redox peaks at E_{1/2}=−0.34 V (vs SHE). This sharp increase in current indicates the catalytic reduction of 0.1 M KCl aerobic aqueous solution to afford H₂ in the presence of 1 mM of the complex (I-3), as evidenced by GC analysis of gas samples in the headspace.

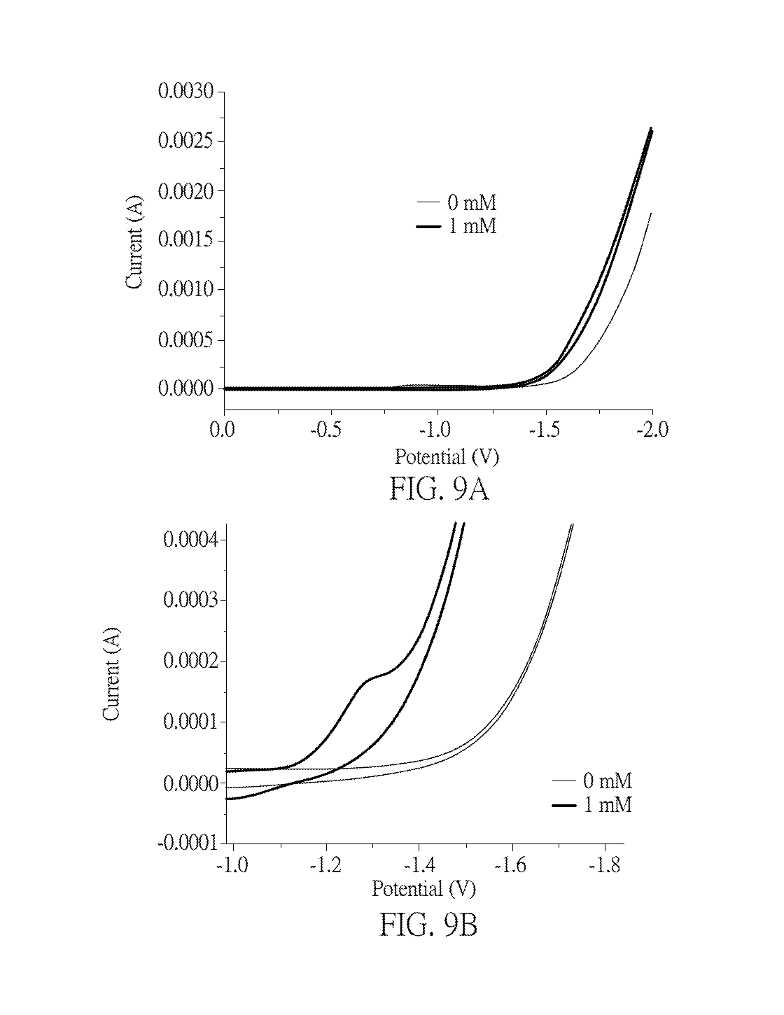

Herein, saturated calomel electrode (SCE) was used as a reference electrode, a glassy carbon electrode (area=0.0707 cm²) was used as a working electrode, and cyclic voltammetry was performed to obtain the oxidation-reduction potential of 0.1 M Na₂SO₄ aqueous solution (or 0.1 M KCl aqueous solution) in the presence (1 mM) and absence (0 mM) of the complex (I-4), at a scan rate of 0.1 Vs (or 0.05 V/s). The results are shown in FIGS. 9A and 9B, wherein FIG. 9B is an enlarge view of FIG. 9A under the condition of the potential being from −1.0 V to −1.8 V. FIGS. 9A and 9B show electrocatalytic H₂-generation from 0.1 M Na₂SO₄ aqueous solution in the presence and absence of 1 mM of the complex (I-4) with an onset potential of −1.10 and −1.50 V, respectively. These results indicate that the dinitrosyl iron complexes of the present invention indeed can reduce the onset reduction potential, and can serve as an effective catalyst for water splitting.

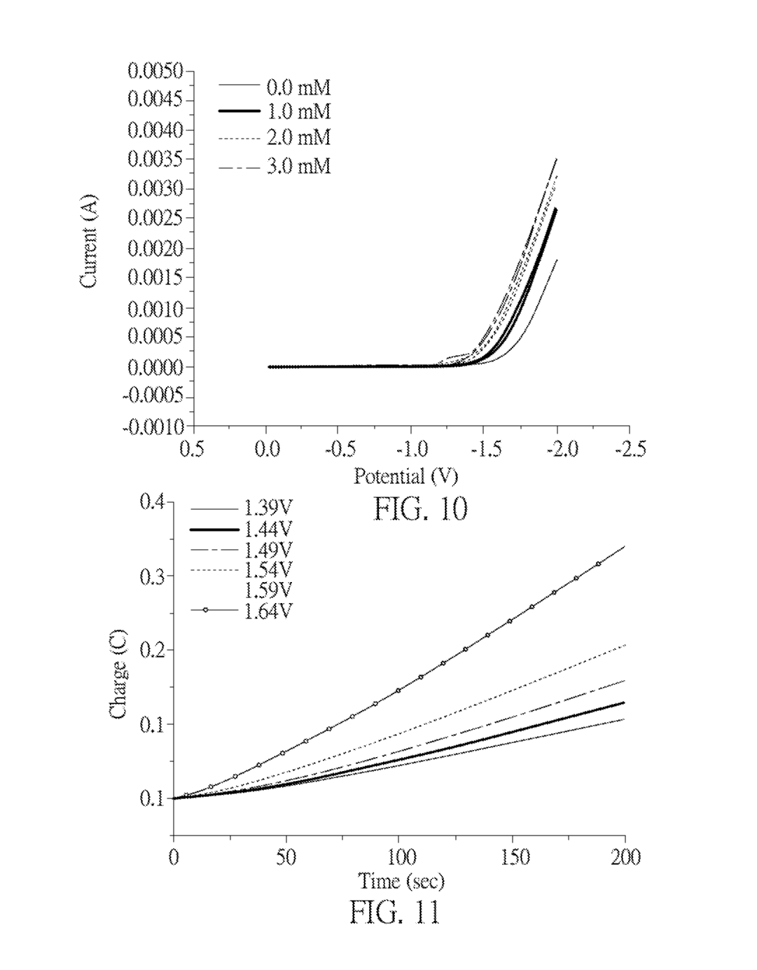

In addition, FIG. 10 shows the cathodic scans of 1 mM, 2 mM and 3 mM aerobic aqueous solution of the complex (I-4) and of the aqueous solution alone in 0.1 M Na₂SO₄ aqueous solutions at pH 7, respectively, on a glassy carbon electrode (A=0.0707 cm²) at a scan rate of 0.1 V/s.

Furthermore, to expand from a reactive inorganic complex toward water reduction, the catalytic efficacy of the complex (I-3) for H₂-generation was evaluated by controlled potential electrolysis (CPE). Considering the practical application, CPE experiment was conducted in the absence of buffer reagents, while 0.1 M Na₂SO₄ was added as electrolyte to minimize internal resistance.

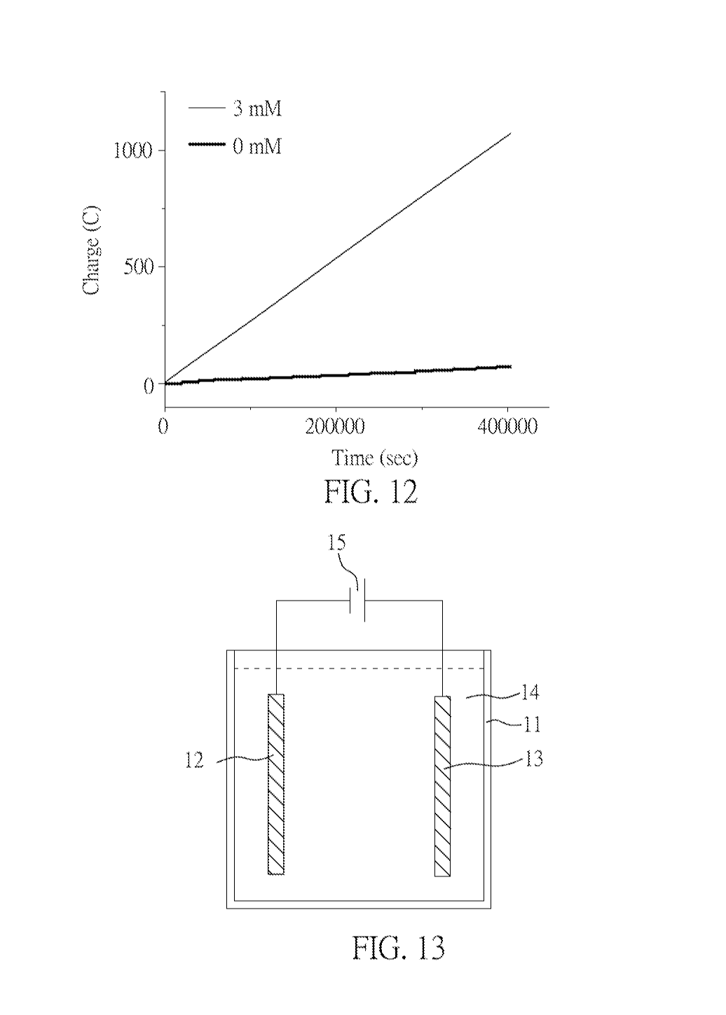

FIG. 11 shows the charge consumption (versus time) by 3 mM aqueous solution of the complex (I-4) at different potential in 0.1 M Na₂SO₄ aqueous solution at pH 7, on a glassy carbon electrode (A=0.0707 cm²) (Reference electrode: Saturated calomel electrode (SCE)). In addition, FIG. 12 represents extended electrolysis data for a 3 mM solution of the complex (I-4) in 0.1 M Na₂SO₄ aqueous solution at pH 7 showing charge build-up versus time with the cell operated at a potential of −1.30 V versus SHE and 0.1 M Na₂SO₄ aqueous solution alone. Turnover number (18.6 mol H₂ (mol (I-4))⁻¹), turnover frequency (0.166 mol H₂ (mol (I-4) h)⁻¹) and current density (38 mA/cm²) are derived from the rate of charge consumption, with the validated 98% Faradaic efficiency. That is, 0.166 moles of H₂ is produced per hour by 1 mole of the complex (I-4) using applied potential of −1.30 V (vs. SCE)

The catalytic turnover frequency for H₂-generation by adding 1 mM of complex (I-3) into 3.0 M KCl aqueous solution (25 mL), on a glassy carbon electrode (A=0.0707 cm²), is 3.76 moles (current density 71.28 mA/cm²) under the controlled potential electrolysis (CPE) experiment using an applying potential of −1.2 V (vs. SHE) for 14 hours. That is 52.64 moles of H₂ is produced per mole of the complex (I-3) using −1.2 V overpotential at pH 7 for 14 hours.

In a similar fashion, the complex (I-3) exhibits steady seawater (Taiwan strait) reduction to produce H₂, under the controlled potential electrolysis (CPE) experiment using an applying potential of −1.25 V (vs. SHE) for 136 hours, with a turnover number of 650.78 (that is 650.78 moles H₂ produced per mole of the complex (I-3)) and current density 90.71 mA/cm² (on a glassy carbon electrode (A=0.0707 cm²)). That is, 325.39 moles of H₂ is produced per mole of the complex (I-3) using −1.25 V overpotential for 136 hours. These results indicate that the dinitrosyl iron complexes of the present invention indeed can be used to split sea water to generate hydrogen gas, and the catalytic property thereof can be maintained after long term operation. Furthermore, chlorine gas was also generated at the auxiliary electrode when sea water was oxidized.

According to the aforementioned results, the dinitrosyl iron complexes of the present invention can be used as a catalyst to generate hydrogen gas effectively. Even though a glassy carbon electrode is used as a working electrode for water splitting, the effect for generating hydrogen gas still can be maintained. In addition, when the dinitrosyl iron complexes of the present invention are used to split sea water or an aqueous solution containing chloride ions, not only hydrogen gas but also chlorine gas can be obtained at the same time. Furthermore, even though the dinitrosyl iron complexes of the present invention are used for a long time, the catalytic activity thereof is still maintained, and the complexes can split water steadily. Herein, the electrocatalytic mechanism of water splitting promoted by the dinitrosyl iron complexes of the present invention is described in the following Scheme I.

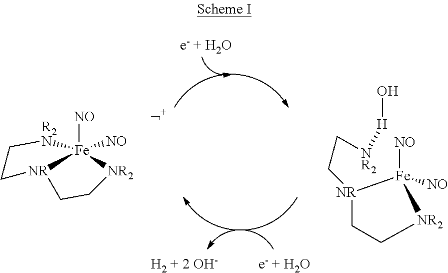

In addition, FIG. 13 is a schematic view showing a water splitting device according to one preferred embodiment of the present invention. The water splitting device of the present invention comprises: a container 11; water 14 disposed in the container 11, wherein a dinitrosyl iron complex is added into the water 14; a first electrode 12, disposed in the container 11 and immersed in the water 14; and a second electrode 13, disposed in the container 11, immersed in the water 14 and opposite to the first electrode 12. Herein, the first electrode 12 can be a working electrode, the second electrode 13 can be a counter electrode or an auxiliary electrode, and an external power supply 15 is electrically connected to the first electrode 12 and the second electrode 13 to provide potential thereto. Preferably, the first electrode 12 can be any working electrode known in the art, such as a Hg electrode, a Pt electrode or a glassy carbon electrode. Preferably, the first electrode 12 is the glassy carbon electrode.

Although the present invention has been explained in relation to its preferred embodiment, it is to be understood that many other possible modifications and variations can be made without departing from the spirit and scope of the invention as hereinafter claimed.

What is claimed is:

1. A dinitrosyl iron complex, represented by the following formula (I):
[(R₁R₂N(CH₂)ₙNR₃(CH₂)ₘNR₄R₅)Fe(NO)₂]^{z} (I)
wherein, each R₁, R₂, R₃, R₄ and R₅ is independently selected from the group consisting of H, halogen, alkyl, alkoxy, aryl, and heteroaryl;
n is 2, 3 or 4;
m is 2, 3, or 4; and
z is −2, −1, 0, +1 or +2.

2. The dinitrosyl iron complex as claimed in claim 1, wherein each R₁, R₂, R₃, R₄ and R₅ is independently selected from the group consisting of H, alkyl, aryl, and pyridine.

3. The dinitrosyl iron complex as claimed in claim 2, wherein each R₁, R₂, R₃, R₄ and R₅ is independently H or alkyl.

4. The dinitrosyl iron complex as claimed in claim 3, wherein each R₁, R₂, R₃, R₄ and R₅ is independently selected from the group consisting of H, methyl, ethyl, n-propyl, iso-propyl, n-butyl, sec-butyl, iso-butyl and tert-butyl.

5. The dinitrosyl iron complex as claimed in claim 1, wherein R₁ and R₂ are identical, and R₄ and R₅ are identical.

6. The dinitrosyl iron complex as claimed in claim 5, wherein all R₁, R₂, R₃, R₄ and R₅ are identical.

7. The dinitrosyl iron complex as claimed in claim 6, wherein all R₁, R₂, R₃, R₄ and R₅ are H, methyl, ethyl, n-propyl, iso-propyl, n-butyl, sec-butyl, iso-butyl or tert-butyl.

8. The dinitrosyl iron complex as claimed in claim 7, wherein all R₁, R₂, R₃, R₄ and R₅ are H, methyl or ethyl.

9. The dinitrosyl iron complex as claimed in claim 1, wherein n and m are the same integers.

10. The dinitrosyl iron complex as claimed in claim 9, wherein both n and m are 2.

11. The dinitrosyl iron complex as claimed in claim 1, wherein z is −1, 0 or +1.

12. The dinitrosyl iron complex as claimed in claim 1, which is represented by the following formula (II) or (III):

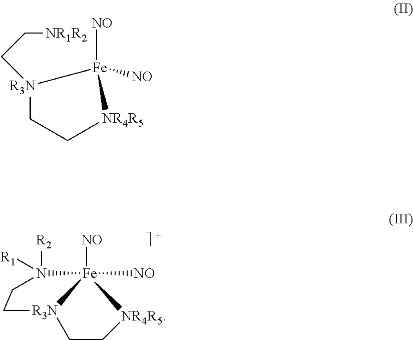

13. A use of a dinitrosyl iron complex for splitting water to generate hydrogen, wherein the dinitrosyl iron complex is represented by the following formula (I):
[(R₁R₂N(CH₂)ₙNR₃(CH₂)ₘNR₄R₅)Fe(NO)₂]^{z} (I)
wherein, each R₁, R₂, R₃, R₄ and R₅ is independently selected from the group consisting of H, halogen, alkyl, alkoxy, aryl, and heteroaryl;
n is 2, 3 or 4;
m is 2, 3, or 4; and
z is −2, −1, 0, +1 or +2.

14. The use as claimed in claim 13, wherein the water is pure water, tap water, or sea water.

15. The use as claimed in claim 14, wherein the water is sea water, and hydrogen and chlorine is generated after splitting the sea water.

16. A water splitting device, comprising:
a container;
water disposed in the container, wherein a dinitrosyl iron complex is added into the water;
a first electrode, disposed in the container and immersed in the water; and
a second electrode, disposed in the container, immersed in the water and opposite to the first electrode,
wherein the dinitrosyl iron complex is represented by the following formula (I):
[(R₁R₂N(CH₂)ₙNR₃(CH₂)ₘNR₄R₅)Fe(NO)₂]^{z} (I)
wherein, each R₁, R₂, R₃, R₄ and R₅ is independently selected from the group consisting of H, halogen, alkyl, alkoxy, aryl, and heteroaryl;
n is 2, 3 or 4;
m is 2, 3, or 4; and
z is −2, −1, 0, +1 or +2.

17. The water splitting device as claimed in claim 16, wherein the water is pure water, tap water, or sea water.

18. The water splitting device as claimed in claim 17, wherein the water is sea water, and hydrogen and chlorine is generated after splitting the sea water.
